(19) United States
(12) Patent Application Publication
(10) Pub. No.: US 2007/0057951 A1
(43) Pub. Date: Mar. 15, 2007

(54) View animation for scaling and sorting

(75) Inventors: Colin R. Anthony, Bothell, WA (US); Justin Mann, Kirkland, WA (US); Martijn E. Van Tilburg, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/341,571

(22) Filed: Jan. 30, 2006

Related U.S. Application Data
(60) Provisional application No. 60/715,598, filed on Sep. 12, 2005.

(51) Int. Cl. G06T 15/70

(52) U.S. Cl. 345/473

(57) ABSTRACT

In an electronic file system environment, animations of file system items are provided in response to various user requests. For example, where the user requests to change the sort order of a set of displayed item representations, the system responds by animating the item representations to move to new destination positions as dictated by the new sort order. Or, where the user requests to resize a container representation, the system responds by animating the item representations shown in the container representation to move about the display to new destination positions as dictated by the new sizing of the container representation. Or, where the user requests to navigate into or out of a container, the system responds by animating item representations shown in the container representation (representing the container to be navigated into) to expand, contract, and/or move about the display to new destination positions and/or sizes.

### CROSS-REFERENCE TO RELATED APPLICATIONS

The present application claims priority to U.S. Provisional Patent Application Ser. No. 60/715,598, entitled “View Animation for Scaling and Sorting,” filed Sep. 12, 2005.

### BACKGROUND

There are many state changes and navigations that occur when viewing items on a computer in a particular view of a file system or other organizational environment. Users may sort the set, navigate into various organizational structures like folders and lists, or even simply resize the window/area that contains the view. In most systems today, these state changes and navigations simply occur, with no intermediate visual transitions of any kind.

### SUMMARY

The use of animations in connection with organizational state changes is provided. Such animations may be useful for helping the user understand the movement between various states.

In accordance with some aspects of the disclosure, an animation may be provided in response to a user request to change the sort order of a set of displayed item representations. This animation may include, for example, one or more of the item representations moving about the display from their initial positions to their new destination positions as dictated by the new sort order.

In accordance with further aspects of the disclosure, an animation may be provided in response to a user request to resize a container representation. This animation may include, for example, one or more of the item representations shown in the container representation moving about the display from their initial positions to their new destination positions as dictated by the new sizing of the container representation.

In accordance with still further aspects of the disclosure, an animation may be provided in response to a user request to navigate into a container. This animation may include, for example, one or more of the item representations shown in the container representation (representing the container to be navigated into) expanding and/or moving about the display from their initial positions and/or sizes to new destination positions and/or sizes.

In accordance with yet further aspects of the disclosure, an animation may be provided in response to a user request to navigate out of a container. This animation may include, for example, one or more of the item representations shown in the container representation (representing the container to be navigated out of) contracting and/or moving about the display from their initial positions and/or sizes to new destination positions and/or sizes.

These and other aspects of the disclosure will be apparent upon consideration of the following detailed description of illustrative embodiments.

### BRIEF DESCRIPTION OF THE DRAWINGS

The foregoing summary, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative computer that may be used to implement various aspects of the present invention.

FIG. 2 is a screenshot showing an illustrative animation that may be presented on a graphical user interface of a computer display in response to a command to change the sort order of items.

FIG. 3 is a screenshot showing an illustrative animation that may be presented on a graphical user interface of a computer display in response to a command to resize a container of items.

FIG. 4 is a screenshot showing an illustrative animation that may be presented on a graphical user interface of a computer display in response to a command to navigate into an organization of items.

FIG. 5 is a screenshot showing an illustrative animation that may be presented on a graphical user interface of a computer display in response to a command to navigate out of an organization of items.

### DETAILED DESCRIPTION OF ILLUSTRATIVE EMBODIMENTS

Illustrative Computing Environment

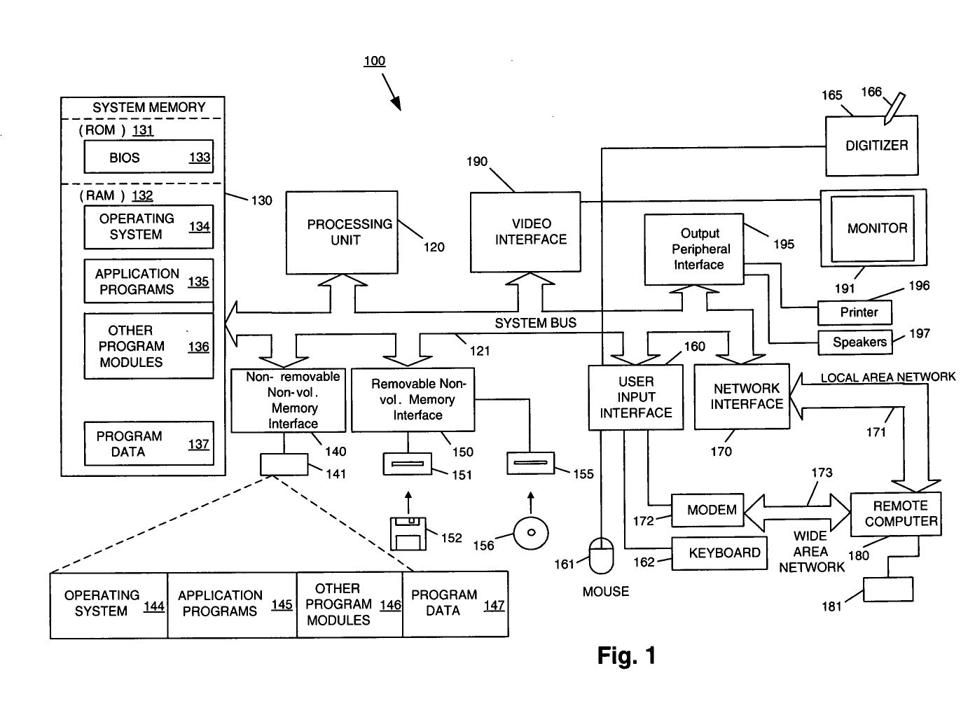

FIG. 1 illustrates an example of a suitable computing system environment 100 in which aspects as described herein may be implemented. Computing system environment 100 is only one example of a suitable computing environment and is not intended to suggest any limitation as to the scope of use or functionality of various aspects as described herein. Neither should computing system environment 100 be interpreted as having any dependency or requirement relating to any one or combination of components illustrated in illustrative computing system environment 100.

One or more other general purpose or special purpose computing system environments or configurations may be used. Examples of well known computing systems, environments, and/or configurations that may be suitable include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the disclosure herein may be described in the general context of computer-executable instructions, such as program modules, stored on one or more computer-readable media and executable by a computer. Generally, program modules include routines, programs, objects, components, data structures, etc. that perform particular tasks or implement particular abstract data types. Embodiments discussed herein may also be operational with distributed computing environments where tasks are performed by remote processing devices that are linked through a communications network. In a distributed computing environment, program modules may be located in both local and remote computer-readable media including memory storage devices.

With reference to FIG. 1, illustrative computing system environment 100 includes a general purpose computing device in the form of a computer 100. Components of computer 100 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 100 typically includes a variety of computer-readable media. Computer readable media can be any available media that can be accessed by computer 100 such as volatile, nonvolatile, removable, and non-removable media. By way of example, and not limitation, computer-readable media may include computer-readable media and communication media. Computer-readable media are tangible media, and may include volatile, nonvolatile, removable, and non-removable media implemented in any method or technology for storage of information such as computer-readable instructions, data structures, program modules or other data. For example, computer-readable media includes random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combination of multiple computer-readable media, are both intended to be included within the scope of the term “computer-readable medium” as described and claimed herein.

System memory 130 includes computer-readable storage media in the form of volatile and/or nonvolatile memory such as ROM 131 and RAM 132. A basic input/output system (BIOS) 133, containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions, including operating system 134, application programs 135, other program modules 136, and program data 137.

Computer 100 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 100. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 100 through input devices such as a keyboard 162 and a pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 191 or other type of display device is also coupled to system bus 121 via an interface, such as a video interface 190. Video interface 190 may have advanced 2D or 3D graphics capabilities in addition to its own specialized processor and memory.

Computer 100 may also include a touch-sensitive device 165, such as a digitizer, to allow a user to provide input using a stylus 166. Touch-sensitive device 165 may either be integrated into monitor 191 or another display device, or be part of a separate device, such as a digitizer pad. Computer 100 may also include other peripheral output devices such as speakers 197 and a printer 196, which may be connected through an output peripheral interface 195.

Computer 100 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 100, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 100 is coupled to LAN 171 through a network interface or adapter 170. When used in a WAN networking environment, computer 100 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 100, or portions thereof, may be stored remotely such as in remote storage device 181. By way of example, and not limitation, FIG. 1 illustrates remote application programs 182 as residing on memory device 181. It will be appreciated that the network connections shown are illustrative, and other means of establishing a communications link between the computers may be used.

As discussed previously, touch-sensitive device 165 may be a device separate from or part of and integrated with computer 100. In addition, any or all of the features, subsystems, and functions discussed in connection with FIG. 1 may be included in, coupled to, or embodied integrally as part of, a tablet-style computer. For example, computer 100 may be configured as a tablet-style computer or a handheld device such as a PDA where touch-sensitive device 165 would be considered the main user interface. In such a configuration touch-sensitive device 165 may be considered to include computer 100. Tablet-style computers are well-known. Tablet-style computers interpret gestures input to touch-sensitive device 165 using stylus 166 in order to manipulate data, enter text, create drawings, and/or execute conventional computer application tasks such as spreadsheets, word processing programs, and the like. Input may not only be made by stylus 166, but also by other types of styli such as a human finger.

Illustrative Electronic File System Environment

An electronic file system may be implemented by computer 100 to manage files and other objects stored in the various electronic media to which computer 100 has access. The file system may be part of the other program modules 136 and/or part of operating system 134. The file system may be a traditional file system that stores files in a hierarchical tree structure. In such a case, each node of the tree is considered a folder that contains one or more files. The location of a file is limited by, and conflated with, its organization within the file system. This means that file locations and directory structure are dependent on one another; when a file is moved to another location, the directory structure also changes to accommodate the new location of the file.

Alternatively, the electronic file system may be more advanced, such as a database-driven file system. In more advanced file systems, shortcut references may be used, allowing files and other objects to appear in one or more locations while actually being in only one of the locations or even in another, completely different location.

In either case, the electronic file system may define various types of objects that provide a relatively flexible way of managing files and other objects. For example, objects may be broadly divided into containers and non-container objects. In general, containers are objects that contains other objects in the file system, whereas non-container objects typically do not contain other objects from the perspective of the file system. A simple example of a container is a folder (e.g., C:\My Documents), and a simple example of a non-container object is a file (e.g., Project.doc), such as a word-processing document, a photo, or an audio file. In addition to files, other types of non-container objects include, but are not limited to, calendar items, emails, and contacts.

In addition to folders, other types of containers include, but are not limited to, lists, persisted auto-lists, and stacks. A list is an object that references a set of other objects in a particular order. The objects referenced by a list are not actually stored in the list as they are in a conventional folder. Thus, more than one list may simultaneously reference the same object. A persisted auto-list is similar to a list except that the set of objects referenced by a persisted auto-list are determined by a query that defines one or more criteria. Thus, a persisted auto-list is a list containing a set of objects that meet one or more criteria of the query. A stack is a virtual container representing the set of items that meet a given requirement, in accordance with a given organization. For instance, the user may define an organization that stacks a persisted auto-list or query results by “author” and then presents all results organized by who wrote them; a different stack may be presented for each author.

The user may interact with objects in the electronic file system via a graphical user interface. The graphical user interface may cause various visual features to be displayed on a display such as monitor 191. For example, the graphical user interface may include displayed representations of each object, or of a subset of the objects, stored by the electronic file system. A representation may be any visual representation such as an icon or a picture. The graphical user interface may also respond to user input. The user input may be received via any user input device such as mouse 161, digitizer 165 and stylus 166, and/or keyboard 162. In response to such user input, computer 100 interprets the input and determines an appropriate action, which may include adjusting what is displayed in the graphical user interface. For example, where a representation is selected by the user, computer 100 may cause the graphical user interface to visually indicate on monitor 191 that the representation has been selected.

Animating Electronic File System Item Representations

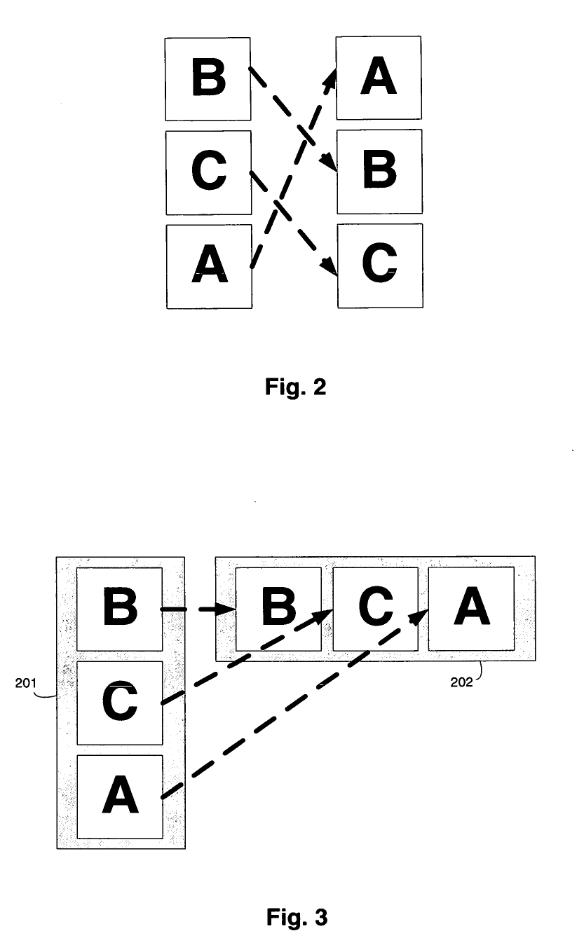

The following discussion of animations in a graphical user interface may be implemented using a computer, such as illustrative computer 100 of FIG. 1, implementing an electronic file system such as described previously. In each of FIGS. 2-5, the broken line arrows represent movement of a representation from a starting point to an ending point, with some movement in between those two locations. This will otherwise be referred to as the animation path. Movement along an animation path may be smooth or it may not be smooth.

An animation is the sequential visual presentation of a graphical element (such as an item representation) in a first state and in a second state, as well as in at least a third state in between the first and second states. For example, where an item representation (also referred to in the present description simply as a representation) moves from a start location to a destination, then the representation can be animated by visually presenting the representation not only in the start and destination locations, but also in at least one intermediate location on the animation path between the start and destination locations. In addition, the intermediate location(s) would be visually presented at a time in between the visual presentation of the start and destination locations. The visual presentation of each state may be at sequential non-overlapping times or at sequential overlapping times.

An item representation may be displayed at numerous displayed intermediate locations along the animation path, such as at each sequential incremented pixel location along the animation path. The number of intermediate displayed positions along an animation path may depend upon the length of the animation path, the speed of movement along the animation path, and/or the desired smoothness of displayed movement. For example, an item representation may be displayed at one hundred or more different sequential intermediate positions along its animation path to give the impression of smooth movement along the animation path. Moreover, states are not limited to location. A state of a graphical element such as an item representation can include a color, size, shape, and/or any other visual property of the graphical element.

Changing Sort Orders. When the sort order of a set of item representations is changed in response to a user input command, each of the affected representations animate from their current positions to their new positions in the new sort order. The animation may thus give the user the impression that the representations are re-ordering themselves.

For example, FIG. 2 shows a plurality of representations A, B, and C in a first displayed order on the left side of FIG. 2. In this example, the order of the representations is, from top to bottom, B, C, A. The right side of FIG. 2 shows a new order of the representations being A, B, C. The new order is requested by the user, such as by dragging and dropping one or more of representations A, B, C, into new positions relative to one another or by a menu command.

In response to the user request, an animation path is determined for each of representations A, B, and C. The animation paths may have endpoints that are the current positions of representations A, B, and C and the destination positions of representations A, B, and C. The configuration of the remaining portions of the animation paths may depend on one or more other factors such as user preferences, the user request itself, or even random factors. Once the animation path has been determined (or while the animation path is being determined), representations A, B, and C animate so as to move along their respective animation paths (indicated by the broken arrows) from their initial positions to their new positions dictated by the new order. While moving along their respective animation paths, each of representations A, B, and C will be displayed in at least one position along their respective animation path that is not the initial position and not the destination position.

In this example, the items represented, or embodied, by representations A, B, and C are each contained within the same container. A container representation for the container is not visually presented in FIG. 2; it is implied. However, a container representation may also be provided, such as box outline enclosing representations A, B, and C.

Resizing Container Representations. When a container representation changes size in response to a user input command, the representations in the view will animate to move from their original positions to their final positions in order to fit within the new size of the container representation. More broadly, the item representations may animate to new positions that depend upon the new size of their parent container representation. The animation may give the user the impression that the items are re-organizing themselves to fit within the newly-resized container representation.

For example, FIG. 3 shows that representations A, B, and C are each in a container embodied by a container representation 201. The left side of FIG. 3 shows the initial position of representations A, B, and C, as well as the initial size of container representation 201. The right side of FIG. 3 shows the new positions of representations A, B, and C, as well as the new size of container representation 201. The new size of container representation 201 is requested by the user, such as by dragging a boundary of container representation 201 and/or by selecting a menu command.

In response to the user request, the animation paths are determined. Also in response to the user request, one or more of representations A, B, C animate by moving along their respective animation paths (indicated by broken arrows) from their initial positions to their new positions as dictated by the new size of the container representation, which is referred to in FIG. 2 as container representation 202. While moving along their respective animation paths, each of representations A, B, and C will be displayed in at least one position along their respective animation path that is not the initial position and not the destination position.

The “size” of a container representation or other item representation may be changed by 1) maintaining the overall shape of the representation but increasing its area, 2) maintaining the area of the representation but changing its overall shape, or 3) changing both the area and overall shape of the representation. In the example of FIG. 3, the area of container representation 202 is the same as the area of container representation 201. However the overall shape of container representation 202 is a horizontal rectangle while the overall shape of container representation 201 is a vertical rectangle, which is different. Thus, the size of container representation 202 is different from the size of container representation 201. To increase or decrease the size of a container representation is to increase or decrease the area of the container representation, respectively.

Depending upon the size of the container representation, all of the items contained therein or only a portion of those items are simultaneously displayed as item representations in the container representation. Where the size of a container representation is increased, additional ones of the item representations may be simultaneously displayed in accordance with the reduced available area in which to display such representations. Where the size of a container representation is decreased, less ones of the item representations may be simultaneously displayed in accordance with the additional available area in which to display such representations.

Navigating Into Containers. When a container or the desktop contains another container (a “sub-container”), a user command to navigate from the current container or the desktop to the sub-container results in an animation of representations of items within that container. The animation may give the user the impression that the container is opening up and/or that the items therein are more readily interactive or available to the user.

As in conventional file folders, a container may be in an open or closed state. Each state may be visualized to the user by a different container representation. Navigation into a container causes the container to be opened, and navigation out of a container causes the container to be closed. Traditionally, the files in a folder could be manipulated by a user only when the folder is in an open state. Depending upon the particular electronic file system used herein, however, the user may also be able to manipulate at least some of the items in a container even when the container is in a closed state. By opening the container, the user may have more full access to the items contained therein, and/or the items contained therein may be represented in a different manner that is easier for the user to manipulate and view. For example, representations may be larger and/or more visually detailed when the parent container is in an open state as compared with when the parent container is in a closed state.

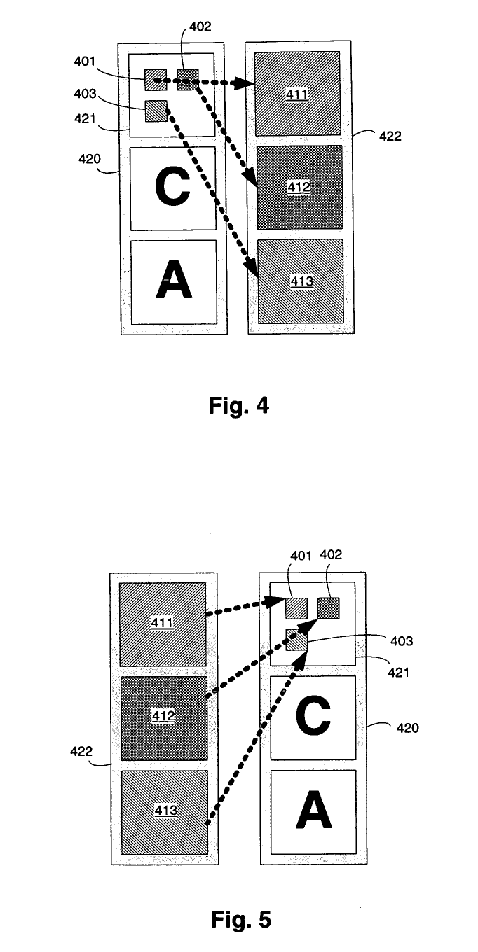

FIG. 4 shows on the left side of the figure an illustrative container representation 420, wherein the represented container is in an open state. The represented container has items therein embodied by representations A, C, and 421. In this example, representation 421 also represents a container containing still further items. Thus, representation 421 in this example is a container representation. In this case, container representation 421 includes displayed within it representations 411, 412, and 413, each representing a different item in the container embodied by container representation 421. Here, container representation 421 indicates a closed container by displaying representations 411, 412, and 413 as being relatively small.

A user may issue a request to navigate into the container embodied by container representation 421. For example, the user may select container representation 421 and double-click on it or select a menu command. In response to the user request, animation paths are determined. Also, in response to the user request, representations 401, 402, 403 are animated to transform into different representations 411, 412, 413, respectively. For instance, during the animation, representations 401, 402, 403 may animate by moving along their respective animation paths (indicated by broken arrows) from their initial positions to their new positions as dictated by the location and/or size of open container representation 422. While moving along their respective animation paths, each of representations 401, 402, and 403 will be displayed in at least one position along their respective animation path that is not the initial position and not the destination position. In addition or alternatively, while moving along their respective animation paths or at a different time, each of representations 401, 402, and 403 may transform into representations 411, 412, and 413, respectively. The transformation may be smooth with one or more intermediary transformations being displayed, or the transformation may be sudden, in a single step. For example, where representation 411 is a zoomed-in version of representation 401, the animation may include a gradual zooming-in of representation 401 over multiple zoom levels, or the animation may include a single-step increase in zoom level.

It is noted that the items embodied by representations 411, 412, 413 are the same items as those embodied by representations 401, 402, 403, respectively. While in the present example representations 411, 412, and 413 are zoomed-in versions of representations 401, 402, 403, respectively, they may be completely different representations altogether. For example, representations 401-403 may each be an icon indicating that the respective item is a word-processing file, while representations 411-413 may each be a thumbnail showing at least a portion of the content of the respective file it represents. When zooming in on a representation, the size of the representation may increase, and the amount of detail displayed may also increase with zoom level.

Navigating Out of Containers. A user command to navigate from a sub-container to a parent container or the desktop results in an animation of representations of items within that container. The animation may give the user the impression that the container is closing and/or that the items therein are less readily interactive or available to the user.

In the example shown in FIG. 5, the animation is effectively the reverse of the animation in FIG. 4. Here, in response to a user request to close the container embodied by container representation 422, animation paths are determined. Also in response to the user request, the following animation may occur. Representations 411, 412, 413 may animate to transform into original representations 401, 402, 403, respectively. For instance, during the animation, representations 411, 412, 413 may animate by moving along their respective animation paths (indicated by broken arrows) from their initial positions to their new positions as dictated by the location and/or size of closed container representation 421. While moving along their respective animation paths, each of representations 411, 412, and 413 will be displayed in at least one position along their respective animation path that is not the initial position and not the destination position. In addition or alternatively, while moving along their respective animation paths or at a different time, each of representations 411, 412, and 413 may transform into representations 401, 402, and 403, respectively. The transformation may be smooth with one or more intermediary transformations being displayed, or the transformation may be sudden, in a single step. For example, where representation 411 is a zoomed-in version of representation 401, the animation may include a gradual zooming-out of representation 411 over multiple zoom levels, or the animation may include a single-step decrease in zoom level.

While animation paths for the illustrative embodiments of FIGS. 2-5 are shown as straight lines in these examples, they may be smoothly curved and/or have sharp corners with multiple straight or curved legs. An animation path may be defined by its start point and its end point where the animation path is straight, and by further points along the animation path where the animation path is not straight. An animation path may depend on the starting configuration (e.g., a starting ordering of the representations, starting positions of the representations, and/or starting sizes of the representations) and the ending configuration (e.g., a destination ordering of representations, the destination positions of the representations, and/or the destination sizes of the representations).

Moreover, the speed of movement along an animation path may be constant or variable. Where variable, the speed may depend upon the location along the animation path. For example, the speed of movement of a representation may be slow near the beginning of the animation, then the speed may become faster, and then later the speed may become slower near the end of the animation as the representation arrives at its destination position. Whether constant or variable, the speed of movement of a representation may depend upon the length of the animation path. For instance, the longer the animation path, the faster the representation movement, and the shorter the animation path, the slower the representation movement.

Further, a representation may additionally animate in any of the discussed examples to show a bounce at or near its destination position. The bounce may be performed by, for example, causing the representation to move up and down and/or back and forth one or more times near the destination position.

In addition, the animation for a particular representation may be partially or fully based on random parameters. This means that the identical user input and state of the user interface at the time of the user input may not necessarily result in the identical animation each time it is performed. This may result in a more natural-looking animation. For example, the speed of movement, bounce, zoom speed, zoom amount, and/or the particular animation path taken may be random.

Also, animations may be determined and planned such that representations move along animation paths so as not to collide with each other and/or such that their animation paths do not cross. Even where their animation paths do cross, the movement speeds of the representations may be set such that the representations do not collide while moving along their respective animation paths.

Further, representations may fade out from being visible at some point along an animation path (e.g., near the start location) and reappear at some later point along the animation path (e.g., near the destination). The reappearance may occur more quickly than if the representation followed the animation path visibly along the entire path at its original speed. This may be especially useful where the animation path is particularly long, so as to shorten the animation time. It is desirable to keep the animation time to a reasonable length so as to provide useful information while not getting in the way of the user. For example, it may be desirable to keep animations under one or two seconds in length.

Still further, software may sense whether computer 100 has a threshold amount of resources to efficiently perform animations. For example, if computer 100 has a graphics card, then the capabilities of the graphics card may be sensed. In response to determining the capabilities, the software may decide whether to cause animations to occur at all, or to set a property of the animations, such as whether to provide a simpler type of animation than would be provided if the graphics card and/or remainder of computer 100 had greater capabilities, or such as the speed, shape, fade, and/or bounce properties of the animation.

Moreover, although a grid-type view of representations is shown in the illustrative embodiments herein, any type of view may be used in connection with animations. For example, representations may or may not be restricted to be displayed at predetermined grid locations that are defmed at a lower resolution than the screen resolution.

Thus, an improved graphical user interface has been described herein in which animations may be provided to give the user additional information about state changes in the reorganization of items and/or the reconfiguration of containers. The graphical user interface and/or the animations performed therein may be embodied as computer-executable instructions stored collectively on one or more computer-readable media. Such instructions may be executed by, for example, computer 100. The graphical user interface and animation instructions may be part of, for instance, the electronic file system software and/or operating system software, or such instructions may be embodied as separate software.

What is claimed is:

1. A computer-readable medium storing computer-executable instructions for performing steps, the steps comprising:
displaying a plurality of item representations each being displayed at a first position, each of the item representations embodying a different item of an electronic file system;
receiving user input; and
in response to the user input, visually animating the plurality of item representations from the respective first positions to different respective second positions.

2. The computer-readable medium of claim 1, wherein the step of visually animating includes displaying each item representation in a third respective position different from the first and second respective positions, at a time that is after the respective item representation is displayed in the first position and before the respective item representation is displayed in the second position.

3. The computer-readable medium of claim 1, wherein the step of visually animating includes:
determining an animation path for each of the plurality of item representations, wherein the animation path for each of the item representations depends upon the respective first position and the respective second position; and
displaying each item representation at a plurality of points along the respective animation path.

4. The computer-readable medium of claim 3, wherein the step of determining includes determining each animation path such that the animation path does not cross the other animation paths.

5. The computer-readable medium of claim 1, wherein the step of visually animating includes moving each of the item representations at speeds that vary during movement.

6. The computer-readable medium of claim 1, wherein each of the item representations represents a different file in the electronic file system.

7. The computer-readable medium of claim 6, wherein each item representation includes a displayed thumbnail of content of the file that the item representation represents.

8. The computer-readable medium of claim 1, wherein the first positions are dictated by a first sort order and the second positions are dictated by a different second sort order, and wherein the user input represents a request to change from the first sort order.

9. The computer-readable medium of claim 1, wherein the step of visually animating includes animating each item representation to bounce.

10. The computer-readable medium of claim 1, further including determining a capability of a computer that is executing the computer-executable instructions, and adjusting a visual animation property in accordance with the capability.

11. A computer-readable medium storing computer-executable instructions for performing steps, the steps comprising:
displaying a container representation, wherein the container representation represents a container in an electronic file system, and wherein the container representation includes a plurality of displayed item representations each being displayed at a first size, wherein each item representation represents an item contained within the container;
receiving user input; and
in response to the user input, visually animating each of the plurality of item representations from the first size to a different second size.

12. The computer-readable medium of claim 11, wherein the step of visually animating includes displaying the plurality of item representations at third respective sizes different from the first and second respective sizes, at a time that is after the item representations are displayed at the first respective sizes and before the item representations are displayed at the second respective sizes.

13. The computer-readable medium of claim 11, wherein each of the item representations represents a different file in the electronic file system.

14. The computer-readable medium of claim 13, wherein each item representation includes a displayed thumbnail of content of the file that the item representation represents.

15. The computer-readable medium of claim 11, wherein the second size of each item representation is larger than the first size of the respective item representation.

16. The computer-readable medium of claim 15, wherein the step of visually animating includes displaying more detail in each of the item representations at the second size than at the first size.

17. The computer-readable medium of claim 11, wherein the step of visually animating further includes moving each item representation from a first position to a different second position, including displaying each item representation at a third position different from the first and second positions at a time that is after the respective item representation is displayed in the first position and before the respective item representation is displayed in the second position.

18. A computer-readable medium storing computer-executable instructions for performing steps, the steps comprising:
displaying a container representation, wherein the container representation represents a container in an electronic file system, and wherein the container representation includes a plurality of displayed item representations, wherein each item representation represents an item contained within the container;
receiving user input;
in response to the user input, changing a size of the container representation; and
in response to the user input, visually animating the plurality of item representations to move from a first position to a different second position within the container representation, wherein the second position is determined in accordance with a changed size of the container representation.

19. The computer-readable medium of claim 18, wherein the step of visually animating further includes displaying each item representation in an intermediate respective position different from the first and second positions, at a time that is after the respective item representation is displayed in the first position and before the respective item representation is displayed in the second position.

20. The computer-readable medium of claim 18, wherein the user input is a drag input that drags a boundary of the container representation.
